(19) United States
(12) Patent Application Publication
(10) Pub. No.: US 2026/0042401 A1
(43) Pub. Date: Feb. 12, 2026

(54) VEHICLE

(71) Applicant: KAWASAKI MOTORS, LTD., Akashi-shi (JP)

(72) Inventor: Kazuki ISHIBASHI, Lincoln, NE (US)

(73) Assignee: KAWASAKI MOTORS, LTD., Akashi-shi (JP)

(21) Appl. No.: 18/797,718

(22) Filed: Aug. 8, 2024

(51) Int. Cl. B60R 7/04

(52) U.S. Cl. CPC B60R 7/043

(57) ABSTRACT

A utility vehicle 100 includes: a front seat 1 which includes a front seat back 11 and on which an occupant sits facing forward; a rear seat 2 which includes a rear seat back 21 adjacent to the front seat back 11 in the front-rear direction and is located rearward of the front seat 1 and on which an occupant sits facing rearward; and the storage 3 that is located between the front seat back 11 and the rear seat back 21 and stores an item.

### FIELD

The technique disclosed here relates to a vehicle.

### BACKGROUND

U.S. Pat. No. 7,980,628 discloses a vehicle including a front seat on which an occupant sits facing forward and a rear seat on which an occupant sits facing rearward.

### SUMMARY

An occupant may load items such as blankets and closing on a vehicle. The vehicle may have available space. It is desirable to make effective use of the available space in the vehicle for loading items.

It is therefore an object of the technique disclosed here to make effective use of an available space in a vehicle for loading items.

A vehicle disclosed here includes: a front seat which includes a front seat back and on which an occupant sits facing forward; a rear seat which includes a rear seat back adjacent to the front seat back in front-rear directions and is located rearward of the front seat and on which an occupant sits facing rearward; and a storage that is located between the front seat back and the rear seat back and stores an item.

A vehicle in another aspect disclosed here includes: a front seat which includes a front seat back and on which an occupant sits facing forward; a rear seat which includes a rear seat back adjacent to the front seat back in front-rear directions and is located rearward of the front seat and on which an occupant sits facing rearward; and a first support frame supporting a first seat back that is one of the front seat back or the rear seat back, wherein a rear surface of the first seat back tilts relative to top-bottom directions, and the first support frame extends upward from bottom along the rear surface of the first seat back.

The vehicle can make effective use of an available space in the vehicle for loading items.

### BRIEF DESCRIPTION OF THE DRAWINGS

FIG. 1 is a side view of a utility vehicle, as seen from the left.

FIG. 2 is a perspective view of a center portion of the utility vehicle, as seen from the right front.

FIG. 3 is a side view of the center portion of the utility vehicle, as seen from the left.

FIG. 4 is a perspective view of the center portion of the utility vehicle, as seen from the upper left.

FIG. 5 is a perspective view of the utility vehicle, as seen from the left rear.

FIG. 6 is a perspective view of the utility vehicle, as seen from the left above.

FIG. 7 is a perspective view of the utility vehicle, as seen from the right front.

FIG. 8 is a side view of a center portion of a utility vehicle according to a variation, as seen from the left.

FIG. 9 is an illustration for describing another example of a storage and is a perspective view of a utility vehicle, as seen from the left front.

FIG. 10 is an illustration for describing another example of the storage and is a perspective view of a utility vehicle, as seen from the left front.

### DESCRIPTION OF EMBODIMENTS

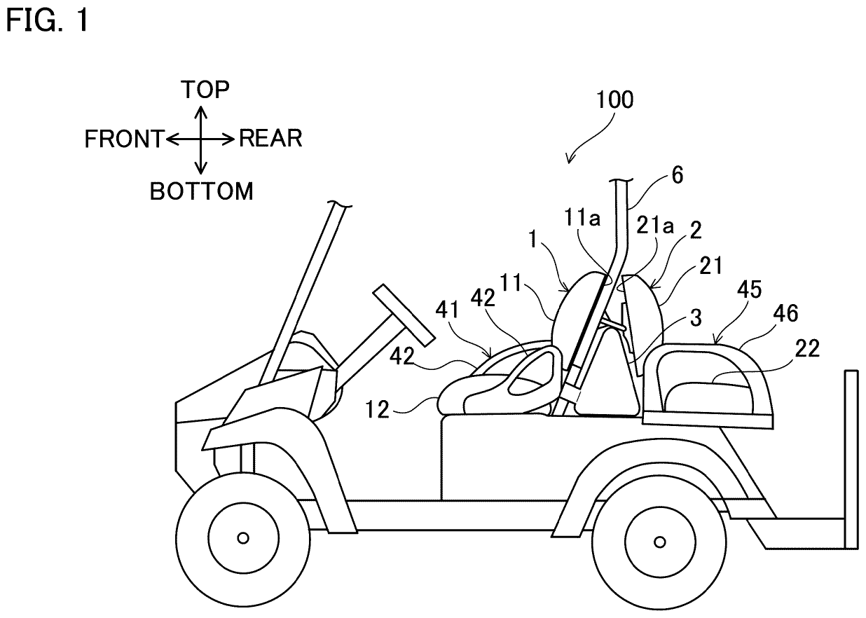

An exemplary embodiment will be described in detail hereinafter with reference to the drawings. FIG. 1 is a side view of a utility vehicle 100, as seen from the left. Hereinafter, the utility vehicle 100 will also be referred to simply as a “vehicle 100.”

The vehicle 100 corresponds to one example of a vehicle disclosed here. The vehicle 100 is a vehicle intended to travel at low speed in a limited area. Examples of the limited area include a limited community area, a private road, and a private property (e.g., a golf course, a park, etc.). The limited community area refers to an area available for use by local residents. The community area is, for example, an area including houses and public facilities (e.g., schools, hospitals, etc.), and is an area where the vehicle 100 not intended to travel on a public road is permitted to travel at low speed. The low speed refers to a speed up 20 mph to 30 mph, for example. The vehicle 100 includes, for example, a personal transport vehicle (PTV). The PTV includes a golf cart.

In this disclosure, components of the vehicle 100 will be described based on directions of the vehicle 100. Specifically, “front” refers to the front of the vehicle 100 in the vehicle front-rear directions, and “rear” refers to the rear of the vehicle 100 in the vehicle front-rear directions. “Left” refers to the left of the vehicle 100 when seeing forward, and “right” refers to the right of the vehicle 100 when seeing forward. The “vehicle width directions” refer to the vehicle width directions of the vehicle 100, in other words, means the left-right directions of the vehicle 100 and will be sometimes referred to as “left-right directions.” An “inner side in the vehicle width directions” refers to a cabin side in the vehicle width directions, and an “outer side in the vehicle width directions” refers to a vehicle outer side in the vehicle width directions. The expression “a member extends or expands in a direction” herein includes not only a case where the member extends or expands strictly in parallel with the direction” but also a case where the member extends or expands generally in the direction.”

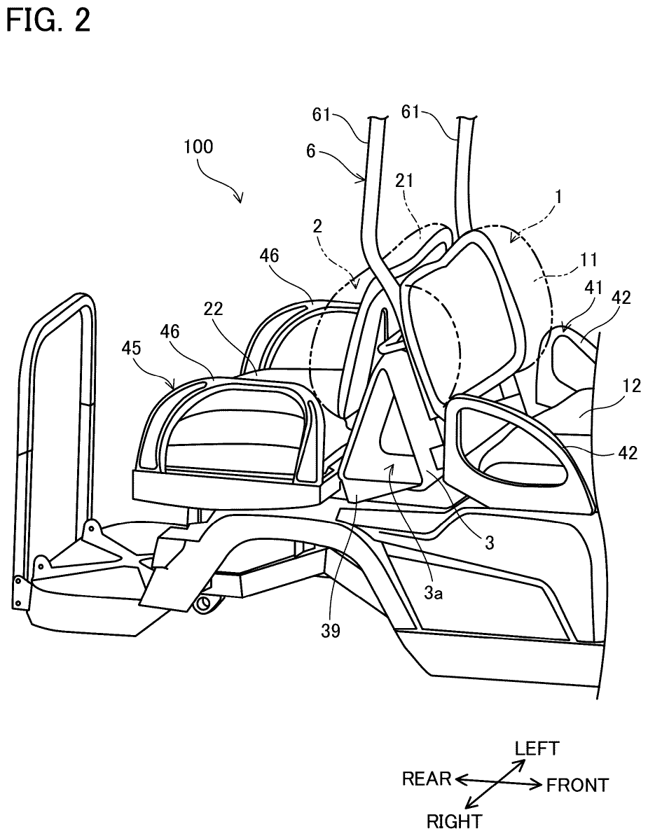

FIG. 2 is a perspective view of a center portion of the vehicle 100, as seen from the right front. The vehicle 100 includes a front seat 1 on which an occupant sits facing forward, a rear seat 2 on which an occupant sits facing rearward, and a storage 3 that stores items. That is, the occupant on the front seat 1 and the occupant on the rear seat 2 board the vehicle 100 in a back-to-back position. The vehicle 100 may further include pillars 6. The pillars 6 are a part of a body frame. The body frame is a frame structure serving as a framework of the vehicle 100.

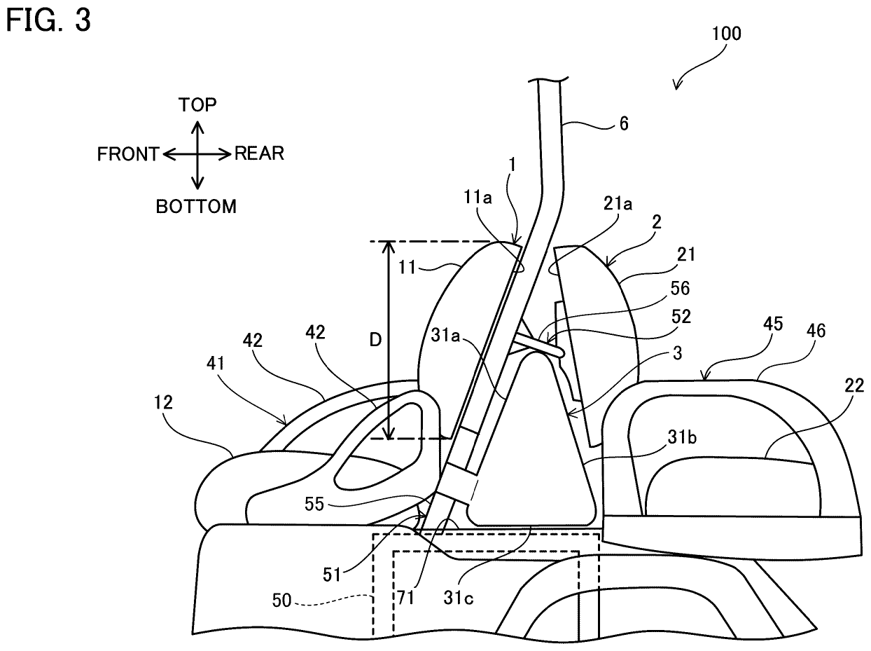

FIG. 3 is a side view of the center portion of the vehicle 100, as seen from the left. The front seat 1 includes a front seat back 11. The front seat back 11 is a member supporting the back of the occupant on the front seat 1. A rear surface 11a of the front seat back 11 tilts relative to the top-bottom directions. Specifically, the rear surface 11a of the front seat back 11 tilts relative to the top-bottom directions to be located further rearward from the bottom toward the top. The rear surface 11a of the front seat back 11 is substantially flat.

The front seat 1 further includes a front seat cushion 12 and a front arm rest 41. The front seat cushion 12 is a member primarily supporting the buttocks of the occupant on the front seat 1. A gap accessible to the storage 3 is present in the top-bottom directions between the front seat back 11 and the front seat cushion 12. That is, the front seat back 11 is located above the front seat cushion 12 in terms of a position in the top-bottom directions. There, a position in the top-bottom directions refers only to a position in the top-bottom directions, without considering positions in directions other than the top-bottom directions, that is, positions in the front-rear directions and the vehicle width directions. The same applies to positions in the vehicle width directions and positions in the front-rear directions. The front arm rest 41 is an example of an arm rest. The front arm rest 41 includes two left and right front arm rests 42. The right front arm rest 42 is located at the right of the front seat cushion 12, and the left front arm rest 42 is located at the left of the front seat cushion 12.

The rear seat 2 includes a rear seat back 21. The rear seat back 21 is a member supporting the back of the occupant on the rear seat 2. The rear seat back 21 is located rearward of the front seat 1. The rear seat back 21 is adjacent to the front seat back 11 in the front-rear directions. A rear surface 21a of the rear seat back 21 tilts relative to the top-bottom directions. Specifically, the rear surface 21a of the rear seat back 21 tilts relative to the top-bottom directions to be located further forward from the bottom toward the top. As described above, the rear surface 11a of the front seat back 11 tilts relative to the top-bottom directions to be located further rearward from the bottom toward the top. Thus, in the vehicle 100, a space where items and others of the occupants can be placed is defined between the rear surface 11a of the front seat back 11 and the rear surface 21a of the rear seat back 21. The rear surface 21a of the rear seat back 21 is substantially flat.

The rear seat 2 further includes a rear seat cushion 22 and a rear arm rest 45. The rear seat cushion 22 is a member primarily supporting the buttocks of the occupant on the rear seat 2. A gap accessible to the storage 3 is present in the top-bottom directions between the rear seat back 21 and the rear seat cushion 22. That is, the rear seat back 21 is located above the rear seat cushion 22 in terms of a position in the top-bottom directions. As illustrated in FIG. 2, the rear arm rest 45 includes two left and right rear arm rests 46. The right rear arm rest 46 is located at the right of the rear seat cushion 22, and the left rear arm rest 46 is located at the left of the rear seat cushion 22.

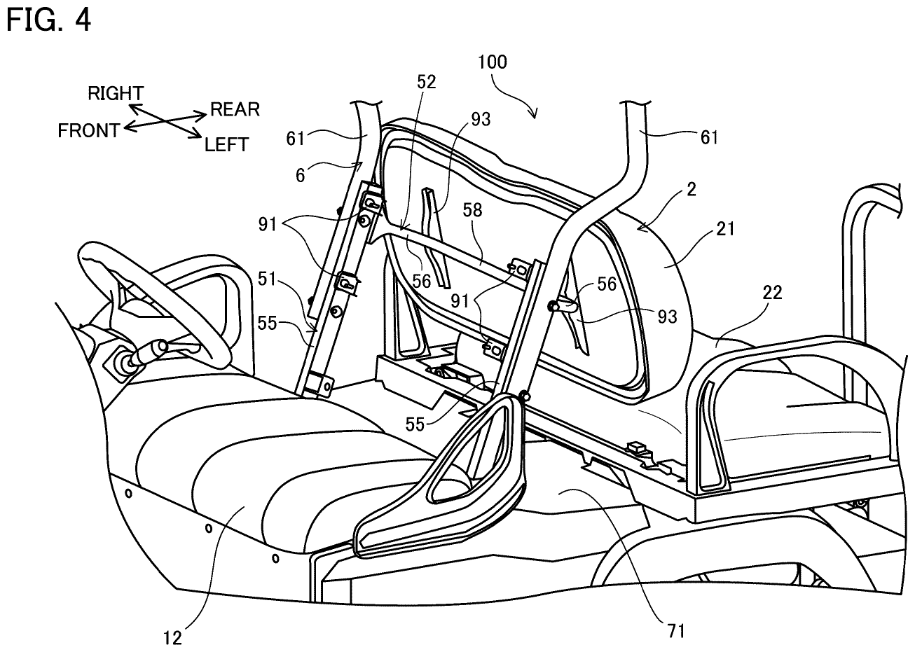

FIG. 4 is a perspective view of the vehicle 100, as seen from the left front. FIG. 4 does not show the front seat back 11 and the storage 3 for convenience of description. The vehicle 100 further includes a first support frame 51 supporting one of the front seat back 11 or the rear seat back 21, and a second support frame 52 supporting the other of the front seat back 11 and the rear seat back 21. The vehicle 100 may further include a floor panel 71 between the front seat cushion 12 and the rear seat cushion 22. The floor panel 71 expands in the front-rear directions and the vehicle width directions as a whole.

The first support frame 51 is a part of the body frame. In this example, the first support frame 51 supports the front seat back 11. The first support frame 51 extends from the bottom toward the top along the rear surface 11a of the front seat back 11 (see FIG. 3). Here, the expression “a first member extends along a second member” includes not only a case where the first member extends in parallel with the second member but also a case where the first member extends generally in parallel with the second member. The first support frame 51 includes two first support frames 55 disposed in the vehicle width directions.

Specifically, each of the first support frames 55 extends upward and rearward from a position rearward of the rear end of the front seat cushion 12. That is, each of the first support frames 55 tilts relative to the top-bottom directions. The tilt angle of each first support frame 55 relative to the top-bottom directions is appropriately equal to the tilt angle of the rear surface 11a of the front seat back 11 relative to the top-bottom directions. In this example, each first support frame 55 is linear. Each first support frame 55 is, for example, metal square pipe. A bracket 91 is fixed to each first support frame 55 by, for example, welding. The front seat back 11 is fastened to the two first support frames 55 through the brackets 91 with, for example, bolts. In this manner, the front seat back 11 is supported by the first support frame 51.

More specifically, as illustrated in FIG. 3, the lower end of each first support frame 51 is fixed to a base frame 50 located below the front seat 1 and the rear seat 2, by, for example, welding. That is, the first support frame 51 is supported by the base frame 50. The first support frame 51 extends upward from the base frame 50 along the rear surface 11a of the front seat back 11. The base frame 50 is a part of the body frame, and a frame serving as a base of frames located above the base frame 50.

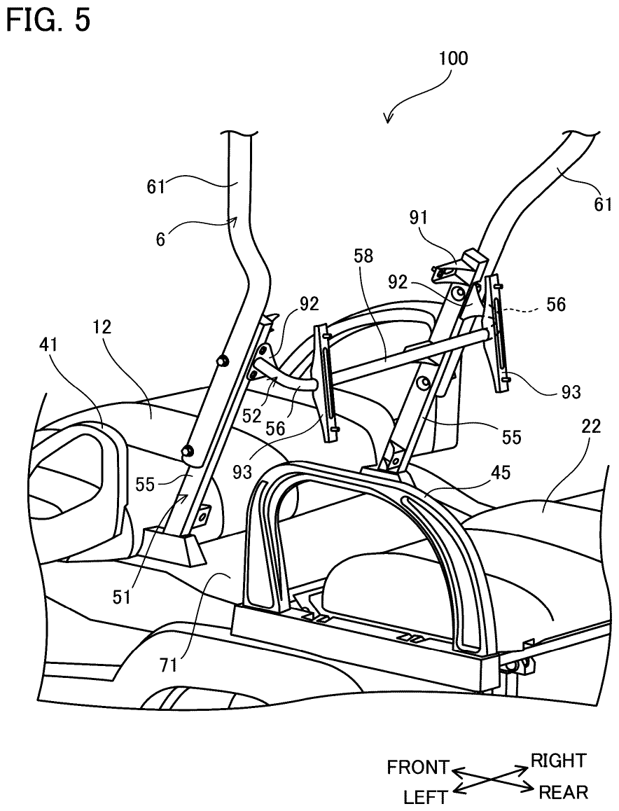

FIG. 5 is a perspective view of the vehicle 100, as seen from the left rear. FIG. 5 does not show the front seat back 11, the rear seat back 21, and the storage 3 for convenience of description. The second support frame 52 is a part of the body frame. In this example, the second support frame 52 supports the rear seat back 21. The second support frame 52 extends from each first support frame 51 toward the rear seat back 21 and is coupled to the first support frame 51 in a cantilever manner. That is, unlike the first support frame 51, the second support frame 52 is not coupled to the base frame 50 (see FIG. 3). The second support frame 52 includes two second support frames 56 disposed in the vehicle width directions.

Specifically, each of the second support frames 56 generally extends in the front-rear directions. A bracket 92 is fixed to the front end of each second support frame 56 by, for example, welding. The right second support frame 56 is fastened to the right first support frame 55 through the bracket 92 with, for example, bolts. The left second support frame 56 is fastened to the left first support frame 55 through the bracket 92 with, for example, bolts. A bracket 93 is fixed to the rear end of each second support frame 56 by, for example, welding. The rear seat back 21 is fastened to each second support frame 56 through the bracket 93 with, for example, bolts. In this manner, the rear seat back 21 is supported by the second support frames 52.

As illustrated in FIG. 3, the second support frame 52 is located above the lower end of the front seat back 11 by ⅓ or more of a distance D in the top-bottom directions between the upper and lower ends of the front seat back 11. In this example, the second support frame 52 is located above the upper end of the front arm rest 41 in terms of a position in the top-bottom directions. Specifically, in terms of a position in the top-bottom directions, the second support frame 52 is located above the upper end of the right front arm rest 42 and above the upper end of the left front arm rests 42. In addition, the second support frame 52 is located above the upper end of the rear arm rest 45 in terms of a position in the top-bottom directions. Specifically, in terms of a position in the top-bottom directions, the second support frame 52 is located above the upper end of the right rear arm rest 46 and above the upper end of the left rear arm rest 46.

As illustrated in FIG. 5, the vehicle 100 further includes a coupling frame 58 coupling to each of the two second support frames 56. The coupling frame 58 extends in the vehicle width directions. The coupling frame 58 is a part of the body frame. In this example, the right end of the coupling frame 58 is coupled to the rear end of the right second support frame 56. The left end of the coupling frame 58 is coupled to the rear end of the left second support frame 56. In this example, the coupling frame 58 and the two second support frames 56 are not separate components, and made of a single member. That is, the coupling frame 58 and the two second support frames 56 are a single continuous frame.

The pillar 6 supports a member located above the front seat back 11 and the rear seat back 21. The pillar 6 is located between the front seat back 11 and the rear seat back 21. The pillar 6 includes a pair of left and right pillars 61. In this example, the pillar 6 extends to a position above the front seat back 11 along the rear surface 11a of the front seat back 11. The pillar 6 is coupled to the first support frame 51. Specifically, as illustrated in FIG. 4, a lower portion of the right pillar 61 is located adjacent to the right first support frame 55 at the right of the right first support frame 55. The lower portion of the right pillar 61 extends approximately in parallel with the right first support frame 55. The lower portion of the right pillar 61 is fastened to the right first support frame 55 with, for example, bolts. Similarly, a lower portion of the left pillar 61 is located adjacent to the left first support frame 55 at the left of the left first support frame 55. The lower portion of the left pillar 61 extends approximately in parallel with the left first support frame 55. The lower portion of the left pillar 61 is fastened to the left first support frame 55 with, for example, bolts.

As illustrated in FIG. 3, in this example, the storage 3 is a bag. The storage 3 is located between the front seat back 11 and the rear seat back 21. Specifically, the storage 3 is located in a space defined between the rear surface 11a of the front seat back 11 and the rear surface 21a of the rear seat back 21. In this example, the storage 3 is detachable from the vehicle 100.

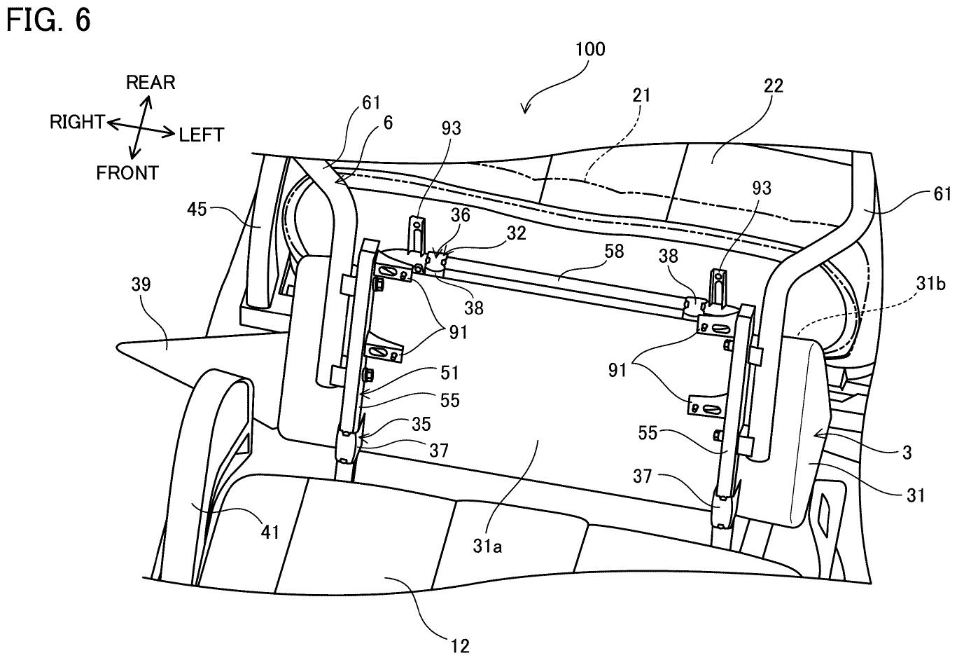

FIG. 6 is a perspective view of the center portion of the vehicle 100, as seen from the left above. FIG. 6 does not show the front seat back 11 for convenience of description. The storage 3 includes a body 31 having an accommodation space therein, and an attachment 32 fixed to the body 31.

The accommodation space of the body 31 stores items of occupants such as blankets and closing. The body 31 extends in the vehicle width directions. In this example, the body 31 has an approximately triangular cross-sectional shape in a plane orthogonal to the vehicle width directions. Specifically, as illustrated in FIG. 3, an outer wall of the body 31 includes a first wall 31a, a second wall 31b, and a third wall 31c. The first wall 31a extends generally along the rear surface 11a of the front seat back 11. The second wall 31b extends generally along the rear surface 21a of the rear seat back 21. The third wall 31c extends generally along the upper surface of the floor panel 71. This shape of the storage 3 minimizes a dead space in the space between the front seat back 11 and the rear seat back 21. The upper end of the body 31 is located above the upper end of the front arm rest 41. The upper end of the body 31 is located above the upper end of the rear arm rest 45. In this example, the position of the upper end of the body 31 generally coincides with the height position of the second support frame 52.

As illustrated in FIG. 6, the attachment 32 is a member for detachably attaching the body 31 to at least one of the first support frame 51 or the second support frame 52. In this example, the attachment 32 is detachably attached to the first support frame 51. In addition, in this example, the attachment 32 is detachably attached to the coupling frame 58. In this example, the attachment 32 is a buckle.

The attachment 32 includes a first attachment 35 and a second attachment 36. The first attachment 35 is detachably attached to the first support frame 51. The second attachment 36 is detachably attached to at least one of the second support frame 52 or the coupling frame 58. In this example, the second attachment 36 is detachably attached to the coupling frame 58. Specifically, the first attachment 35 includes two left and right first attachments 37. The two first attachments 37 are fixed to the lower end of the first wall 31a of the body 31. The right first attachment 37 is detachably attached to the right first support frame 55. The left first attachment 37 is detachably attached to the left first support frame 55. The second attachment 36 includes two left and right second attachments 38. The two second attachments 38 are fixed to the upper end of the second wall 31b of the body 31. The right second attachment 38 is detachably attached to a portion of the coupling frame 58 at the right of the center in the vehicle width directions. The left second attachment 38 is detachably attached to a portion of the coupling frame 58 at the left of the center in the vehicle width directions.

As illustrated in FIG. 2, the storage 3 includes a loading port 3a for loading and unloading items in at least one of the end surfaces in the vehicle width directions. In this example, the storage 3 includes a loading port 3a in the right end surface. The storage 3 further includes a lid 39 covering at least a portion of the loading port 3a. The lid 39 is attached to the body 31 to open and close the loading port 3a. In this example, the lid 39 fully closes the loading port 3a in a state where the loading port 3a is closed.

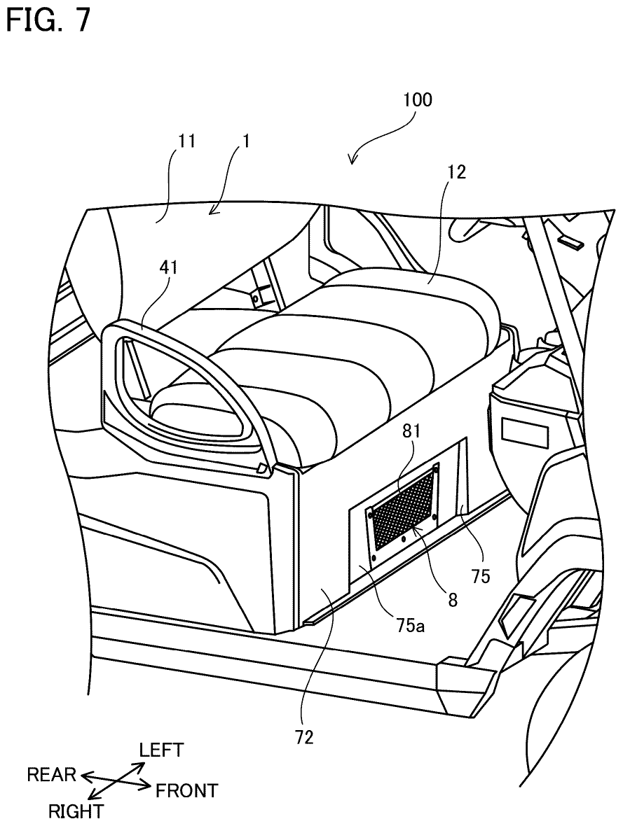

FIG. 7 is a perspective view of the vehicle 100, as seen from the right front. FIG. 7 does not show the storage 3 for convenience of description. The vehicle 100 may further include an under-seat panel 72. The under-seat panel 72 is located below the front seat cushion 12. The under-seat panel 72 extends in the vehicle width directions and the top-bottom directions as a whole. The under-seat panel 72 includes a recess 75 that is recessed rearward. The recess 75 has a surface 75a facing forward. The surface 75a extends in the vehicle width directions and the top-bottom directions. The surface 75a is substantially flat. The surface 75a is equipped with a housing pocket 8 extending in the vehicle width directions and the top-bottom directions. The housing pocket 8 stores items such as personal belongings of an occupant. The housing pocket 8 has an extendable net 81.

In the vehicle 100 described above, since the storage 3 is located between the front seat back 11 and the rear seat back 21, the occupants on the front seat 1 and the rear seat 2 can store items in the storage 3. Accordingly, it is possible to load items while making effective use of an available space between the front seat back 11 and the rear seat back 21.

The pillar 6 extends to a position above the front seat back 11 along the rear surface 11a of the front seat back 11. Accordingly, an installation space for the storage 3 is obtained. The first support frame 51 also extends along the rear surface 11a of the front seat back 11. Accordingly, an installation space for the storage 3 is further obtained.

The vehicle 100 includes a second support frame 52 coupled to the first support frame 51 in a cantilever manner and supporting the rear seat back 21. If the vehicle 100 does not include the second support frame 52 and the rear seat back 21 is supported by, for example, a plurality of frames extending in the top-bottom directions, the structure of the body frame becomes complicated to cause the possibility of narrowing the installation space for the storage 3. The configuration in which the rear seat back 21 is supported by the second support frames 52 simplifies the structure of the body frame to thereby obtain the installation space for the storage 3.

Further, in this example, the second support frames 52 are located above the lower end of the front seat back 11 by ⅓ or more of a distance D in the top-bottom directions between the upper and lower ends of the front seat back 11. In addition, the second support frames 52 are located above the upper end of the front arm rest 41 in terms of a position in the top-bottom directions. The second support frames 52 are located above the upper end of the rear arm rest 45 in terms of a position in the top-bottom directions. Accordingly, an installation space for the storage 3 in the top-bottom directions is obtained.

In this example, the vehicle 100 includes a coupling frame 58 coupled to each of the two second support frames 56 and extending in the vehicle width directions. Accordingly, support rigidity of the rear seat back 21 is enhanced.

The storage 3 includes the attachment 32 fixed to the body 31 and detachably attached to at least one of the first support frame 51 or the second support frame 52. This can prevent the storage 3 from falling off. In addition, a user can take the storage 3 out of the vehicle 100. This enhances convenience of the storage 3. In particular, in this example, the attachment 32 includes the first attachment 35 detachably attached to the first support frame 51, and the second attachment 36 detachably attached to at least one of the second support frame 52 or the coupling frame 58. That is, the storage 3 is attached to the body frame in at least two portions. Accordingly, rattles of the storage 3 during traveling can be reduced.

The storage 3 has the loading port 3a for loading and unloading items in at least one of the end surfaces in the vehicle width directions. This enables the user to access the accommodation space inside the storage 3 from the outside in the vehicle width directions. In addition, since the storage 3 includes the lid 39 covering at least a portion of the loading port 3a, the possibility of items falling out of the storage 3 can be reduced.

In this example, the front seat back 11 tilts relative to the top-bottom directions to be located further rearward from the bottom toward the top, and the rear seat back 21 tilts relative to the top-bottom directions to be located further forward from the bottom toward the top. Accordingly, a larger space can be obtained in a lower portion of a space between the front seat back 11 and the rear seat back 21 than in an upper portion.

Since the gap accessible to the storage 3 is present in the top-bottom directions between the front seat back 11 and the front seat cushion 12, the occupant on the front seat 1 can access the storage 3 through the gap. Since the gap accessible to the storage 3 is present in the top-bottom directions between the rear seat back 21 and the rear seat cushion 22, the occupant on the rear seat 2 can access the storage 3 through the gap.

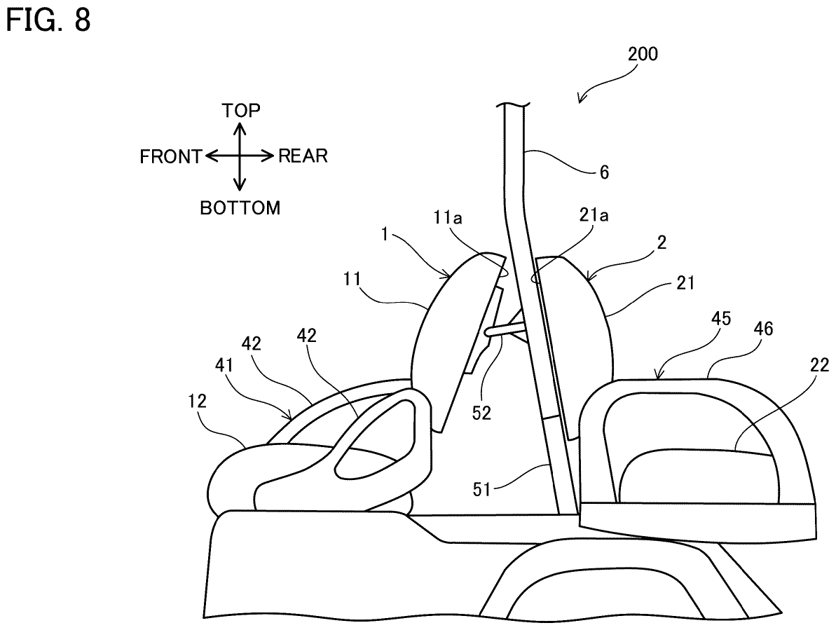

Next, a utility vehicle 200 according to a variation will be described. FIG. 8 is a side view of a center portion of the utility vehicle 200 according to the variation. as seen from the left. The utility vehicle 200 (hereinafter referred to simply as a “vehicle 200”) is different from the vehicle 100 in arrangement of the first support frame 51, the second support frame 52, and the pillar 6 and including no storage 3. The other components are the same as those of the vehicle 100, and are denoted by the same reference characters as those in the vehicle 100 and will not be described below.

In this example, the first support frame 51 supports the rear seat back 21. The first support frame 51 extends upward from the bottom along the rear surface 21a of the rear seat back 21. Specifically, the first support frame 51 extends upward and forward from a position forward of the front end of the rear seat cushion 22. That is, the first support frame 51 tilts relative to the top-bottom directions. The tilt angle of the first support frame 51 relative to the top-bottom directions is appropriately equal to the tilt angle of the rear surface 21a of the rear seat back 21 relative to the top-bottom directions. The structure for attaching the rear seat back 21 to the first support frame 51 is the same as that in the vehicle 100, and thus, will not be described in detail.

In this example, the second support frame 52 supports the front seat back 11. The second support frame 52 extends from the first support frame 51 toward the front seat back 11 and is coupled to the first support frame 51 in a cantilever manner. The other part of the configuration of the second support frame 52 is the same as that of the second support frame 52 of the vehicle 100, and thus, will not be described in detail.

The pillar 6 extends to a position above the rear seat back 21 along the rear surface 21a of the rear seat back 21. The pillar 6 is coupled to the first support frame 51. Specifically, a lower portion of the pillar 6 extends approximately in parallel with the first support frame 51. The lower portion of the pillar 6 is fastened to the first support frame 51 with, for example, bolts.

In the vehicle 200, the pillar 6 extends to a position above the rear seat back 21 along the rear surface 21a of the rear seat back 21. Accordingly, a space for placing items and others of occupants is obtained between the front seat back 11 and the rear seat back 21. The first support frame 51 also extends along the rear surface 21a of the rear seat back 21. Accordingly, a space for placing items and others of the occupants is further obtained between the front seat back 11 and the rear seat back 21. In addition, the configuration in which the front seat back 11 is supported by the second support frames 52 simplifies the structure of the body frame to thereby further obtain a space for placing items and others of the occupants between the front seat back 11 and the rear seat back 21.

### Other Embodiments

In the foregoing section, the embodiment has been described as an example of the technique disclosed in the present application. The technique disclosed here, however, is not limited to this embodiment, and is applicable to other embodiments obtained by changes, replacements, additions, and/or omissions as necessary. Components described in the above embodiment may be combined as a new exemplary embodiment. Components provided in the accompanying drawings and the detailed description can include components unnecessary for solving problems as well as components necessary for solving problems in order to exemplify the technique. Therefore, it should not be concluded that such unnecessary components are necessary only because these unnecessary components are included in the accompanying drawings or the detailed description.

For example, the vehicle 100 may include three or more rows of seats. In the case of a vehicle having three rows of seats, the storage 3 may be located between the first row of seats and the second row of seats, or may be located between the second row of seats and the third row of seats. The vehicle 100 may also be a three-wheeled vehicle having three wheels, or may be a six-wheeled vehicle having six wheels.

Both the rear surface 11a of the front seat back 11 and the rear surface 21a of the rear seat back 21 may not tilt relative to the top-bottom directions. That is, the vehicle may have a configuration in which the rear surface 11a of the front seat back 11 tilts relative to the top-bottom directions and the rear surface 21a of the rear seat back 21 is approximately parallel to the top-bottom directions, a configuration in which the rear surface 11a of the front seat back 11 is approximately parallel to the top-bottom directions and the rear surface 21a of the rear seat back 21 tilts relative to the top-bottom directions, or a configuration in which the rear surface 11a of the front seat back 11 is approximately parallel to the top-bottom directions and the rear surface 21a of the rear seat back 21 is also approximately parallel to the top-bottom directions.

The gap accessible to the storage 3 may not be present in the top-bottom directions between the front seat back 11 and the front seat cushion 12. The gap accessible to the storage 3 in the top-bottom directions may not be present between the rear seat back 21 and the rear seat cushion 22.

THE vehicle 100 may not include the pillar 6.

The configuration of the body frame is not limited to the configuration described above. For example, the body frame may not include the second support frames 52. In this case, suppose the two first support frames 55 located in the vehicle width directions are defined as a first support frame set, the vehicle 100 may include two first support frame sets. In a manner similar to the example illustrated in FIG. 3, one of the first support frame sets may extend upward from the bottom along the rear surface 11a of the front seat back 11 and support the front seat back 11. The other first support frame set may extend upward from the bottom along the rear surface 21a of the rear seat back 21 and support the rear seat back 21. The lower end of each of the first support frames 55 in the other first support frame set is fixed to the base frame 50 by, for example, welding. For example, the body frame may not include the coupling frame 58. The configuration of the body frame according to the variation is also applicable to the body frame of the vehicle 100.

The second supports frame 52 may not be located above the lower end of the front seat back 11 by ⅓ or more of the distance D in the top-bottom directions between the upper and lower ends of the front seat back 11. The second support frames 52 may be located below the upper end of the front arm rest 41. The second support frames 52 may be located below the upper end of the rear arm rest 45.

The attachment 32 is not limited to a buckle. For example, the attachment 32 may be a Hook-and-Loop fastener. The attachment 32 may be detachably attached to at least one of the first support frame 51, the second support frames 52, or the coupling frame 58. The storage 3 may not include the attachment 32. In this case, the storage 3 may be non-detachably attached to at least one of the first support frame 51 or the second support frames 52.

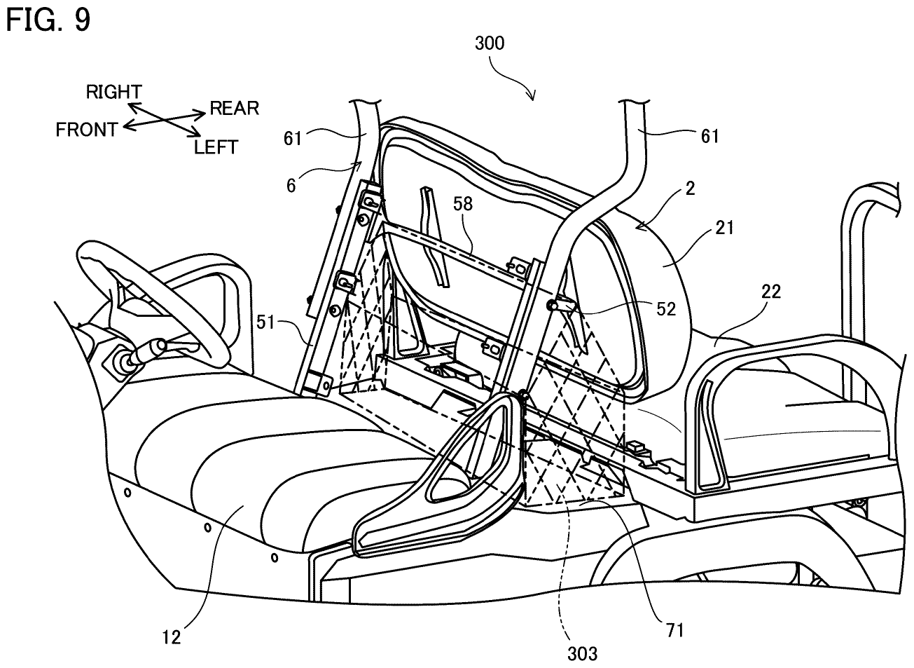

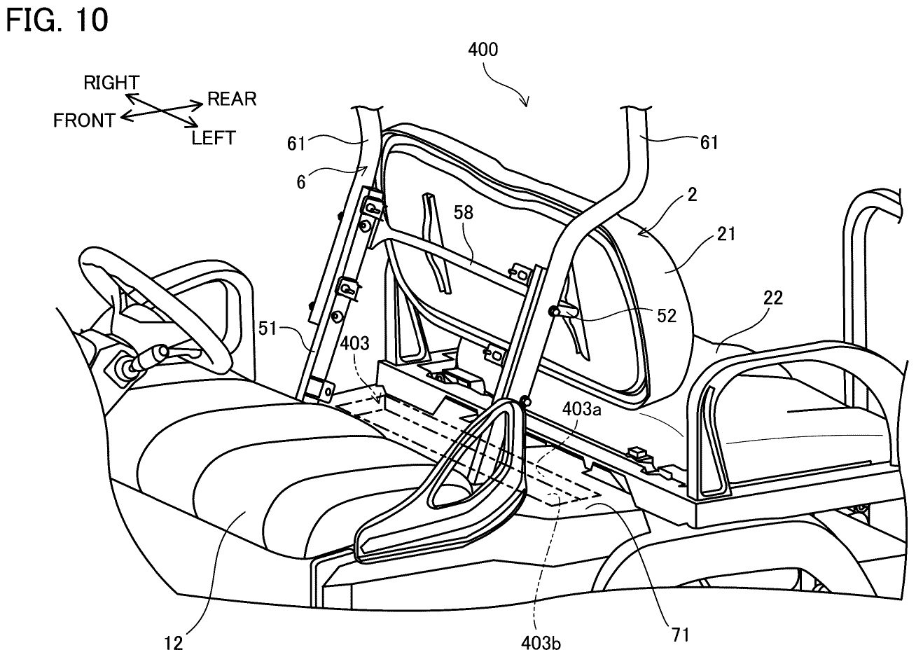

The storage is not limited to a bag. FIG. 9 is an illustration for describing another example of the storage and is a perspective view of a utility vehicle 300, as seen from the left front. FIG. 9 does not show the front seat back 11 for convenience of description. For example, the storage 303 may be a net defining at least outer sides of a space between the front seat back 11 and the rear seat back 21 in the vehicle width directions. Items of the occupants are stored on the inner side of the net. The net restricts outward movement of the items in the vehicle width directions during traveling to prevent the items from falling off. FIG. 10 is an illustration for describing another example of the storage and is a perspective view of a utility vehicle 400, as seen from the left front. FIG. 10 does not show the front seat back 11 for convenience of description. For example, a storage 403 may be a recess that is recessed downward on the floor panel 71. In the example illustrated in FIG. 10, the recess is defined by a side wall 403a extending in the top-bottom directions and bottom wall 403b extending in the front-rear directions and the vehicle width directions. Items of the occupants are stored in the recess. The storage may be a projection projecting upward from the upper surface of the floor panel 71.

The storage 3 may have a loading port 3a on each end surface on the outer sides in the vehicle width directions.

The vehicle of the present disclosure may be an off-road vehicle or an on-road vehicle. The off-road vehicle may be, for example, an all terrain vehicle (ATV), a tractor, or other vehicles.

### ASPECTS

The embodiment described above are a specific example of the following aspects.

### Aspect 1

A vehicle (utility vehicle 100) includes: the front seat 1 which includes a front seat back 11 and on which an occupant sits facing forward; the rear seat 2 which includes the rear seat back 21 adjacent to the front seat back 11 in front-rear directions and is located rearward of the front seat 1 and on which an occupant sits facing rearward; and the storage 3 that is located between the front seat back 11 and the rear seat back 21 and stores an item.

In this configuration, since the storage 3 is located between the front seat back 11 and the rear seat back 21, the occupants on the front seat 1 and the rear seat 2 can store items in the storage 3. Accordingly, it is possible to load items while making effective use of an available space between the front seat back 11 and the rear seat back 21.

### Aspect 2

The vehicle described in Aspect 1 further includes the pillar 6, and the pillar 6 is located between the front seat back 11 and the rear seat back 21, and either extends to a position above the front seat back 11 along the rear surface 11a of the front seat back 11 or extends to a position above the rear seat back 21 along the rear surface 21a of the rear seat back 21.

In this configuration, since the pillar 6 extends along the rear surface 11a of the front seat back 11 or the rear surface 21a of the rear seat back 21, an installation space for the storage 3 can be obtained.

### Aspect 3

The vehicle described in Aspect 1 or 2 further includes the first support frame 51 supporting a first seat back that is one of the front seat back 11 or the rear seat back 21, and the first support frame 51 extends upward from the bottom along the rear surface of the first seat back.

In this configuration, since the first support frame 51 extends along the rear surface of the first seat back, an installation space for the storage 3 can be further obtained.

### Aspect 4

The vehicle described in any one of Aspects 1 through 3 further includes the second support frame 52 supporting a second seat back that is another of the front seat back 11 or the rear seat back 21, and the second support frame 52 extends from the first support frame 51 to the second seat back and is coupled to the first support frame 51 in a cantilever manner.

If the vehicle does not include the second support frame 52 and the second seat back is supported by, for example, a plurality of frames extending in the top-bottom directions, the structure of the body frame becomes complicated to cause the possibility of narrowing the installation space for the storage 3. In this configuration, since the second seat back is supported by the second support frame 52, the configuration of the body frame is simplified, and the installation space for the storage 3 can be further obtained.

### Aspect 5

In the vehicle described in any one of Aspects 1 through 4, the second support frame 52 is located above the lower end of the first seat back by ⅓ of the distance D between the upper end and the lower end of the first seat back in the top-bottom directions.

In this configuration, an installation space for the storage 3 in the top-bottom directions can be obtained.

### Aspect 6

In the vehicle described in any one of Aspects 1 through 5, at least one of the front seat 1 or the rear seat 2 further includes the arm rest (the front arm rest 41 or the rear arm rest 45), and the second support frame 52 is located above the upper end of the arm rest in terms of a position in the top-bottom directions.

In this configuration, an installation space for the storage 3 in the top-bottom directions can be obtained.

### Aspect 7

In the vehicle described in any one of Aspects 1 through 6, the first support frame 51 includes the two first support frames 55 located in the vehicle width directions, the second support frame 52 includes two second support frames 56, and the vehicle further includes the coupling frame 58 coupled to each of the two second support frames 56 and extending in the vehicle width directions.

This configuration can further enhance support rigidity of the rear seat back 21.

### Aspect 8

In the vehicle described in any one of Aspects 1 through 7, the storage 3 is a bag.

In this configuration, the storage 3 that stores items and prevents the items from falling off can be obtained.

### Aspect 9

The vehicle described in any one of Aspects 1 through 8 further includes: the first support frame 51 extending upward from the bottom along the rear surface of a first seat back that is one of the front seat back 11 or the rear seat back 21, the first support frame supporting the first seat back; and the second support frame 52 supporting a second seat back that is another of the front seat back 11 or the rear seat back 21 and extending from the first support frame 51 toward the second seat back, the second support frame being coupled to the first support frame 51 in a cantilever manner, and the storage 3 includes the body 31 having the accommodation space therein and detachably attached to at least one of the first support frame 51 or the second support frame 52.

In this configuration, since the storage 3 is detachably attached to at least one of the first support frame 51 or the second support frame 52, falling off of the storage 3 can be prevented. In addition, the user can take the storage 3 out of the vehicle 100. This enhances convenience of the storage 3.

### Aspect 10

In the vehicle described in any one of Aspects 1 through 9, the storage 303 is the net defining at least an outer side of a space between the front seat back 11 and the rear seat back 21 in vehicle width directions.

In this configuration, the storage 303 that stores items and prevents the items from falling off can be obtained.

### Aspect 11

In the vehicle described in any one of Aspects 1 through 10, the front seat 1 further includes the front seat cushion 12, the rear seat 2 further includes the rear seat cushion 22, the vehicle further includes the floor panel 71 located between the front seat cushion 12 and the rear seat cushion 22, and the storage 403 is a recess that is recessed downward on the floor panel 71.

In this configuration, the storage 403 that stores items and prevents the items from falling off can be obtained.

### Aspect 12

In the vehicle described in any one of Aspects 1 through 11, the rear surface of at least one of the front seat back 11 or the rear seat back 21 tilts relative to top-bottom directions. In this configuration, an installation space for the storage 3 can be easily obtained.

### Aspect 13

In the vehicle described in any one of Aspects 1 through 12, the rear surface 11a of the front seat back 11 tilts relative to the top-bottom directions to be located further rearward from bottom toward top.

In this configuration, a larger space can be obtained in a lower portion of a space between the front seat back 11 and the rear seat back 21 than in an upper portion. In addition, the riding comfort of an occupant on the front seat 1 is improved, as compared to a case where the rear surface 11a of the front seat back 11 is approximately parallel to the top-bottom directions, for example.

### Aspect 14

In the vehicle described in any one of Aspects 1 through 13, the rear surface 21a of the rear seat back 21 tilts relative to the top-bottom directions to be located further forward from bottom toward top.

In this configuration, a larger space can be obtained in a lower portion of a space between the front seat back 11 and the rear seat back 21 than in an upper portion. In addition, the riding comfort of an occupant on the rear seat 2 is improved, as compared to a case where the rear surface 21a of the rear seat back 21 is approximately parallel to the top-bottom directions, for example.

### Aspect 15

In the vehicle described in any one of Aspects 1 through 14, the storage 3 is a bag, and includes the loading port 3a for loading and unloading the item in at least one of end surfaces in vehicle width directions.

This configuration enables a user to access the accommodation space inside the storage 3 from the outside in the vehicle width directions.

### Aspect 16

In the vehicle described in any one of Aspects 1 through 15, the storage 3 further includes the lid 39 covering at least a portion of the loading port 3a.

This configuration can reduce the possibility of items falling out of the storage 3.

### Aspect 17

In the vehicle described in any one of Aspects 1 through 16, the front seat 1 further includes the front seat cushion 12, and a gap accessible to the storage 3 is present in the top-bottom directions between the front seat back 11 and the front seat cushion 12.

This configuration enables an occupant on the front seat 1 to access the storage 3 through the gap.

### Aspect 18

In the vehicle described in any one of Aspects 1 through 17, the rear seat 2 further includes the rear seat cushion 22, and a gap accessible to the storage 3 is present in the top-bottom directions between the rear seat back 21 and the rear seat cushion 22.

This configuration enables an occupant on the rear seat 2 to access the storage 3 through the gap.

### Aspect 19

A vehicle (utility vehicle 200) includes: the front seat 1 which includes the front seat back 11 and on which an occupant sits facing forward; the rear seat 2 which includes the rear seat back 21 adjacent to the front seat back 11 in the front-rear directions and is located rearward of the front seat 1 and on which an occupant sits facing rearward; and the first support frame 51 supporting a first seat back that is one of the front seat back 11 or the rear seat back 21, the rear surface of the first seat back tilts relative to the top-bottom directions, and the first support frame 51 extends upward from the bottom along the rear surface of the seat back.

In this configuration, since the first support frame 51 extends along the tilting rear surface of the first seat back, it is possible to obtain a space for placing items of occupants between the front seat back 11 and the rear seat back 21.

1. A vehicle comprising:
a front seat which includes a front seat back and on which an occupant sits facing forward;
a rear seat which includes a rear seat back adjacent to the front seat back in front-rear directions and is located rearward of the front seat and on which an occupant sits facing rearward; and
a storage that is located between the front seat back and the rear seat back and stores an item.

2. The vehicle according to claim 1, further comprising
a pillar, wherein
the pillar is located between the front seat back and the rear seat back, and either extends to a position above the front seat back along a rear surface of the front seat back or extends to a position above the rear seat back along a rear surface of the rear seat back.

3. The vehicle according to claim 1, further comprising
a first support frame supporting a first seat back that is one of the front seat back or the rear seat back, wherein
the first support frame extends upward from bottom along a rear surface of the first seat back.

4. The vehicle according to claim 3, further comprising
a second support frame supporting a second seat back that is another of the front seat back or the rear seat back, wherein
the second support frame extends from the first support frame toward the second seat back and is coupled to the first support frame in a cantilever manner.

5. The vehicle according to claim 4, wherein
the second support frame is located above a lower end of the first seat back by ⅓ of a distance between an upper end and the lower end of the first seat back in top-bottom directions.

6. The vehicle according to claim 4, wherein
at least one of the front seat or the rear seat further includes an arm rest, and
the second support frame is located above an upper end of the arm rest in terms of a position in top-bottom directions.

7. The vehicle according to claim 4, wherein
the first support frame includes two first support frames located in vehicle width directions,
the second support frame includes two second support frames located in the vehicle width directions, and
the vehicle further comprises a coupling frame coupled to each of the two second support frames and extending in the vehicle width directions.

8. The vehicle according to claim 1, wherein
the storage is a bag.

9. The vehicle according to claim 8, further comprising:
a first support frame extending upward from bottom along a rear surface of a first seat back that is one of the front seat back or the rear seat back, the first support frame supporting the first seat back; and
a second support frame supporting a second seat back that is another of the front seat back or the rear seat back and extending from the first support frame toward the second seat back, the second support frame being coupled to the first support frame in a cantilever manner, wherein
the storage includes a body having an accommodation space therein, and an attachment that is fixed to the body and detachably attached to at least one of the first support frame or the second support frame.

10. The vehicle according to claim 1, wherein
the storage is a net defining at least an outer side of a space between the front seat back and the rear seat back in vehicle width directions.

11. The vehicle according to claim 1, wherein
the front seat further includes a front seat cushion,
the rear seat further includes a rear seat cushion,
the vehicle further comprises a floor panel located between the front seat cushion and the rear seat cushion, and
the storage is a recess that is recessed downward on the floor panel.

12. The vehicle according to claim 1, wherein
a rear surface of at least one of the front seat back or the rear seat back tilts relative to top-bottom directions.

13. The vehicle according to claim 12, wherein
the rear surface of the front seat back tilts relative to the top-bottom directions to be located further rearward from bottom toward top.

14. The vehicle according to claim 12, wherein
the rear surface of the rear seat back tilts relative to the top-bottom directions to be located further forward from bottom toward top.

15. The vehicle according to claim 1, wherein
the storage is a bag, and includes a loading port for loading and unloading the item in at least one of end surfaces in vehicle width directions.

16. The vehicle according to claim 15, wherein
the storage further includes a lid covering at least a portion of the loading port.

17. The vehicle according to claim 1, wherein
the front seat further includes a front seat cushion, and
a gap accessible to the storage is present in top-bottom directions between the front seat back and the front seat cushion.

18. The vehicle according to claim 1, wherein
the rear seat further includes a rear seat cushion, and
a gap accessible to the storage is present in top-bottom directions between the rear seat back and the rear seat cushion.

19. A vehicle comprising:
a front seat which includes a front seat back and on which an occupant sits facing forward;
a rear seat which includes a rear seat back adjacent to the front seat back in front-rear directions and is located rearward of the front seat and on which an occupant sits facing rearward; and
a first support frame supporting a first seat back that is one of the front seat back or the rear seat back, wherein
a rear surface of the first seat back tilts relative to top-bottom directions, and
the first support frame extends upward from bottom along the rear surface of the first seat back.
